(19) United States
(12) Patent Application Publication
(10) Pub. No.: US 2010/0011285 A1
(43) Pub. Date: Jan. 14, 2010

(54) INFORMATION PROCESSING APPARATUS, INFORMATION PROCESSING METHOD, INFORMATION PROCESSING SYSTEM, AND PROGRAM

(75) Inventors: Masaru KAWATA, Nagano (JP); Tomohiro Tsuyuhara, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/487,817

(22) Filed: Jun. 19, 2009

(30) Foreign Application Priority Data
Jul. 11, 2008 (JP) 2008-181870
Aug. 6, 2008 (JP) 2008-203394

(51) Int. Cl. G06F 17/00

(52) U.S. Cl. 715/246

(57) ABSTRACT

An information processing apparatus includes an output section, a display screen, and a screen arrangement section. The output section outputs image information for a presentation to an external display apparatus. The display screen is capable of displaying information. The screen arrangement section arranges a first area and a second area on the display screen with a positional relationship preset for the display screen, the first area displaying an image corresponding to the image information that has been output to the external display apparatus, the second area being an area in which the image information can be edited.

### BACKGROUND OF THE INVENTION

1. Field of the Invention

The present invention relates to an information processing apparatus such as a laptop personal computer, an information processing method, an information processing system, and a program.

2. Description of the Related Art

As a system that handles integrally different media elements such as moving images, still images, texts, and audio, an MMS (Multimedia Messaging Service) is used, for example. The MMS is based on a SMIL (Synchronized Multimedia Integration Language) that is being standardized as an application language of an XML (extensible Markup Language). The MMS is a mechanism in which the different media elements such as moving images, still images, texts, and audio are integrated into a synchronized multimedia presentation in accordance with a description of the SMIL that is to be a scenario of the different media elements.

With the SMIL, a layout (position and size), a timing, etc. of visual media elements such as moving images, still images, and texts, and a timing etc. of auditory media elements can be described.

There is a technique disclosed in Japanese Patent Application Laid-open No. 2004-56469 (paragraph [0010], FIG. 2) (hereinafter, referred to as Patent Document 1) in which, by using the system as described above, a screen that a user is displaying on a cellular phone or the like is optimized and displayed in conformity with various conditions on a size, a resolution, and the like of a display screen of a television set, without depending on a change of a layout description language such as the SMIL.

### SUMMARY OF THE INVENTION

The technique disclosed in Patent Document 1 does not necessarily facilitate a presentation when a user makes the presentation using an electronic apparatus such as a cellular phone.

For example, when a user makes a presentation using a laptop personal computer and a projector, a screen displayed on a display screen of the laptop personal computer that the user is using is the same as a screen displayed for audiences on a large-size screen by the projector. For that reason, there is a problem that it is difficult for the user to satisfactorily make the presentation since, during the presentation, the user can hardly edit data on a screen of a presentation application.

Moreover, the user often makes a presentation while facing audiences with his/her back to the large-size screen, for example. In this case, there is a problem that it is difficult for the user to satisfactorily make the presentation since the user needs to turn around to check the screen of the large-size screen.

In view of the circumstances as described above, there is a need for an information processing apparatus, an information processing method, and a program with which a presentation can be made more easily.

According to an embodiment of the present invention, there is provided an information processing apparatus including an output means, a display screen, and a screen arrangement means. The output means outputs image information for a presentation to an external display apparatus. The display screen is capable of displaying information. The screen arrangement means arranges a first area and a second area on the display screen with a positional relationship preset for the display screen, the first area displaying an image corresponding to the image information that has been output to the external display apparatus, the second area being an area in which the image information can be edited.

In the embodiment of the present invention, the screen arrangement means arranges the first area and the second area on the display screen with the positional relationship preset for the display screen, the first area displaying the image corresponding to the image information that is output to the external display apparatus by the information processing apparatus, the second area being capable of editing the image information, and thus the image information of the second area can be edited while viewing the image corresponding to the image information that is output to the external display apparatus during the presentation. Accordingly, the presentation is made more easily.

The information processing apparatus according to the embodiment of the present invention may further include a setting means for receiving a setting of on/off of the screen arrangement means which is made by a user.

With such a structure, arrangement of screens can be changed easily by the setting means. In other words, screen arrangement that can support a presentation easily can be obtained by the user merely making a setting once by the setting means. It should be noted that by the setting, a presentation setting as a setting for facilitating a presentation may be set. The presentation setting is a setting for preventing automatic activation of a screen saver, preventing a laptop personal computer from automatically entering a sleep mode during the presentation by the user, or the like. With such a structure, a complicated setting for making a presentation can be set automatically.

In the information processing apparatus according to the embodiment of the present invention, the screen arrangement means may arrange a screen of an application other than the presentation as a third area on the display screen in addition to the first area and the second area.

With such a structure, the information processing apparatus can display image information that is different from an image of the first area and an image of the second area on the display screen. The user can make a presentation by referring to image information of the third area while viewing the image of the first area and the image of the second area.

The information processing apparatus according to the embodiment of the present invention may further include an input means for receiving an input of an operation signal from a user, and means for causing the setting means to display a setting screen for receiving the setting of on/off of the screen arrangement means which is made by a user on the display screen in accordance with the operation signal.

With such a structure, the user can input the operation signal using the input means when wishing to change settings, and the setting screen can thus be displayed on the display screen.

The information processing apparatus according to the embodiment of the present invention may further include means for setting whether to display the third area on the display screen or not.

With such a structure, the third area is displayed or hidden on the display screen selectively.

In the information processing apparatus according to the embodiment of the present invention, the third area may include a fourth area that is a screen of a first application that supports a presentation, and a fifth area that is a screen of a second application that does not support the presentation, and the screen arrangement means may arrange the fourth area to be larger than the fifth area.

In this case, the first application that supports a presentation includes an application for taking notes and an application for displaying materials for the presentation. The second application that does not support a presentation includes an application of game software, for example.

With such a structure, the fourth area that supports a presentation during the presentation can be displayed larger than the fifth area, with the result that a presentation can be made more easily.

The information processing apparatus according to the embodiment of the present invention may further include a display control means for controlling the number of times processing for displaying the image in the first area is performed per unit time.

With such a structure, a load on the information processing apparatus can be reduced, and screens can be displayed on the display screen smoothly.

The information processing apparatus according to the embodiment of the present invention may further include an illumination control means for controlling illumination of a screen of the external display apparatus.

With such a structure, a presentation screen can be prevented from becoming excessively bright during the presentation.

The information processing apparatus according to the embodiment of the present invention may further include an enlargement/reduction ratio control means for controlling an enlargement/reduction ratio of the image displayed in the first area.

With such a structure, the image displayed in the first area can be enlarged and reduced during the presentation, with the result that a presentation can be made more smoothly.

According to an embodiment of the present invention, there is provided an information processing apparatus including an output means and a second output means. The output means outputs first information to a first display apparatus. The second output means outputs a first area and a second area to a second display apparatus in accordance with positions preset for the second display apparatus, the first area displaying information corresponding to the first information that has been output to the first display apparatus, the second area being an area for editing the first information that has been output to the first display apparatus.

According to another embodiment of the present invention, there is provided an information processing method including outputting, by an information processing apparatus, image information for a presentation to an external display apparatus. With a positional relationship preset for a display screen of the information processing apparatus, a first area and a second area are arranged on the display screen, the first area displaying an image corresponding to the image information, the second area being an area in which the image information can be edited.

In the embodiment of the present invention, with the positional relationship preset for the display screen, the first area and the second area are arranged on the display screen, the first area displaying the image corresponding to the image information that is output to the external display apparatus by the information processing apparatus, the second area being capable of editing the image information, and thus the image information of the second area can be edited while viewing the image corresponding to the image information that is output to the external display apparatus during the presentation. Accordingly, the presentation is made more easily.

The information processing method according to the embodiment of the present invention may further include prompting a user to set on/off of the arrangement of the first area and the second area on the display screen.

Accordingly, the presentation can be supported easily by the user merely making a setting once.

According to still another embodiment of the present invention, there is provided an information processing system including an external display apparatus and an information processing apparatus. The external display apparatus is input with image information for a presentation. The information processing apparatus includes an output means, a display screen, and a screen arrangement means. The output means outputs the image information for presentation to the external display apparatus. The display screen is capable of displaying information. The screen arrangement means arranges a first area and a second area on the display screen with a positional relationship preset for the display screen, the first area displaying an image corresponding to the image information that has been output to the external display apparatus, the second area being an area in which the image information can be edited.

In the embodiment of the present invention, the image information of the second area can be edited while viewing the image corresponding to the image information that is output to the external display apparatus during the presentation. Accordingly, the presentation is made more easily.

According to still another embodiment of the present invention, there is provided a program causing a computer to function as an information processing apparatus, the program causing the computer to execute outputting image information for a presentation to an external display apparatus. With a positional relationship preset for a display screen of the information processing apparatus, a first area and a second area are arranged on the display screen, the first area displaying an image corresponding to the image information, the second area being an area in which the image information can be edited.

In the embodiment of the present invention, the image information of the second area can be edited while viewing the image corresponding to the image information that is output to the external display apparatus during the presentation. Accordingly, the presentation is made more easily.

According to still another embodiment of the present invention, there is provided an information processing method, including: outputting, by an information processing apparatus, first information to a first display apparatus; and outputting a first area and a second area to a second display apparatus in accordance with positions preset for the second display apparatus, the first area displaying information corresponding to the first information that has been output to the first display apparatus, the second area being an area for editing the first information that has been output to the first display apparatus.

According to still another embodiment of the present invention, there is provided an information processing apparatus including an output section and a second output section. The output section outputs first information to a first display apparatus. The second output section outputs a first area and a second area to a second display apparatus in accordance with positions preset for the second display apparatus, the first area displaying information corresponding to the first information that has been output to the first display apparatus, the second area being an area for editing the first information that has been output to the first display apparatus.

As described above, according to the embodiments of the present invention, the presentation can be made more easily.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing an information processing system according to an embodiment of the present invention;

FIG. 2 is a perspective view of a state where a laptop personal computer shown in FIG. 1 is closed;

FIG. 3 is a block diagram showing a configuration of hardware of the laptop personal computer;

FIG. 4 is a flowchart showing an operation at a time of activation of the laptop personal computer;

FIG. 5 is a diagram showing a display setting screen that is displayed at the time of activation of the laptop personal computer;

FIG. 6 is a diagram showing a flowchart of desktop extended display processing;

FIG. 7 is a diagram showing an example of a display screen of the laptop personal computer in a desktop extended display mode;

FIG. 8 is a diagram showing a setting change screen of presentation software;

FIG. 9 is a diagram showing a display screen of a desktop extended display of a first modified example;

FIG. 10 is a diagram showing an information processing system of a second modified example; and

FIG. 11 is a diagram showing an example of an operation using laptop personal computers 2 and 2′.

### DESCRIPTION OF PREFERRED EMBODIMENTS

Hereinafter, an embodiment of the present invention will be described with reference to the drawings.

In this embodiment, a laptop personal computer and a projector will be exemplified as an information processing apparatus and an external display apparatus, respectively, and there will be described a case where an image or the like that is displayed on a display screen of a laptop personal computer (main body display) is displayed on a large-size screen using, for example, a projector (external display).

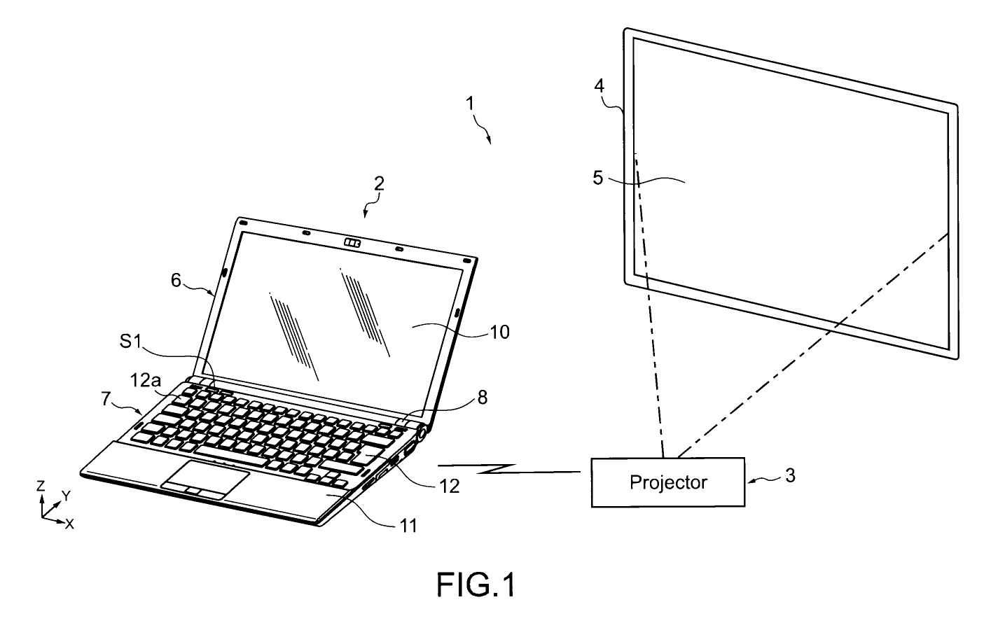

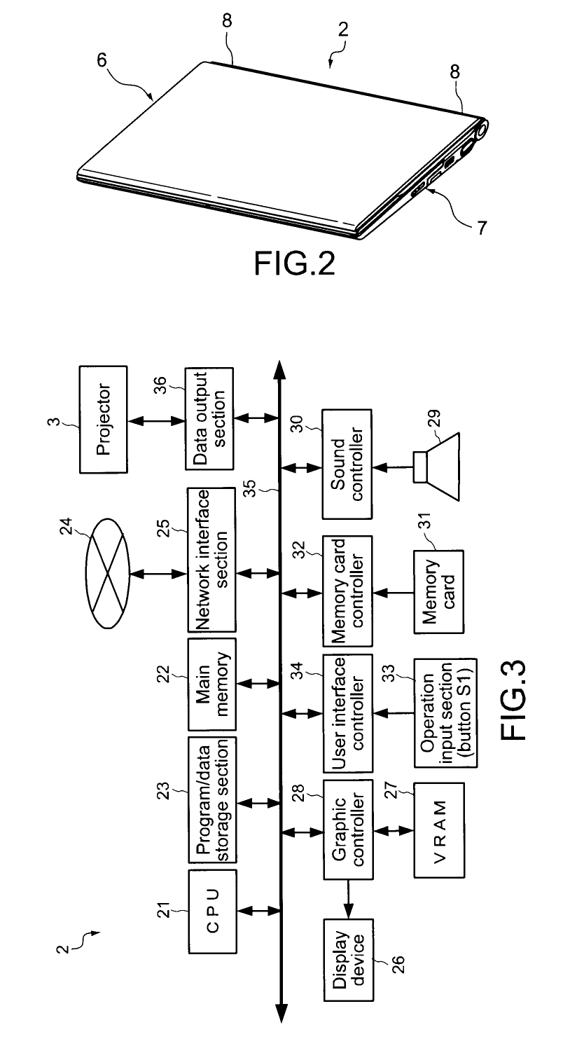

FIG. 1 is a diagram showing an information processing system according to the embodiment of the present invention. FIG. 2 is a perspective view of a state where the laptop personal computer shown in FIG. 1 is closed.

An information processing system 1 includes, for example, a laptop personal computer 2, a projector 3, and a large-size screen 4. The laptop personal computer 2 and the projector 3 are connected to enable wired or wireless data communication, for example. The laptop personal computer 2 transmits, for example, image information for a presentation to the projector 3. The projector 3 receives the image information for a presentation and projects and displays an enlarged presentation screen 5 for a presentation on the large-size screen 4.

The laptop personal computer 2 includes a display portion 6, a main body portion 7, and a hinge portion 8 for coupling those display portion 6 and main body portion 7.

The display portion 6 is openable (foldable) with respect to the main body portion 7 via the hinge portion 8 as shown in FIGS. 1 and 2. A liquid crystal display panel (not shown) is accommodated in the display portion 6. The display portion 6 includes a display screen 10 for displaying information, the display screen 10 facing the main body portion 7 in a closed state.

The main body portion 7 includes a casing 11 in which a keyboard unit 12 and units such as a system board, a hard disk drive, and an optical disk drive (all of which are not shown) are incorporated. The keyboard unit 12 includes, for example, a plurality of keys 12a and functions as an input portion of the laptop personal computer 2. A push-button display mode changing switch S1 that is used to change display modes to be described later of the laptop personal computer 2 and the projector 3 is disposed on the casing 11.

The display mode changing switch S1 is provided in the vicinity of the hinge portion 8 of the main body portion 7 of the laptop personal computer 2, for example. By a user pressing the display mode changing switch S1, the main body portion 7 displays or hides a display setting screen that is used to change display modes to be described later on the display screen 10.

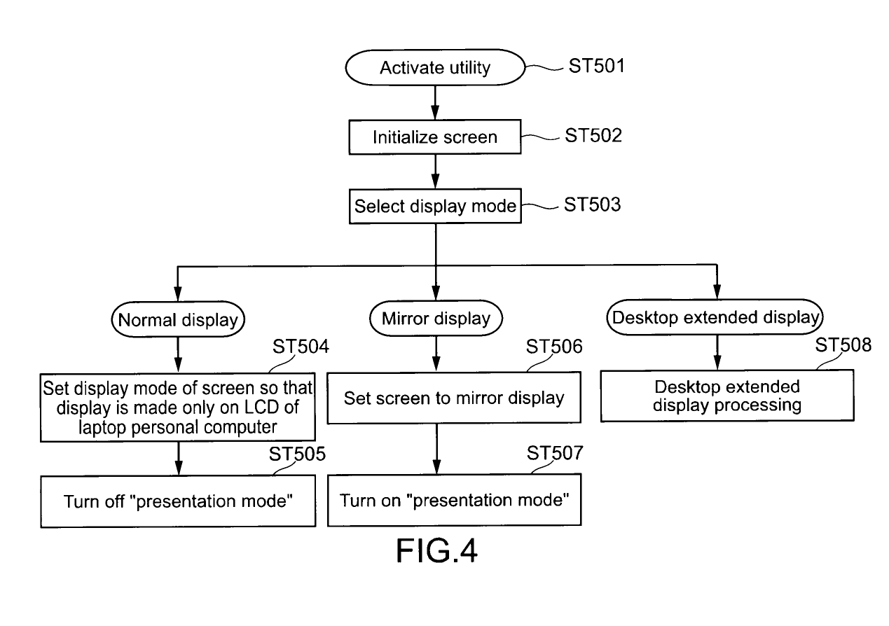

FIG. 3 is a block diagram showing a configuration of hardware of the laptop personal computer 2 shown in FIG. 1.

As shown in the figure, the laptop personal computer 2 includes a CPU (Central Processing Unit) 21, a main memory 22, a program/data storage section 23, a network interface section 25 for processing connection with a network 24 such as the Internet, a display device 26 for visually providing information to a user, a graphic controller 28 for performing drawing processing on the display device 26 using a VRAM (Video Random Access Memory) 27, a speaker 29 for aurally providing information to a user, a sound controller 30 for processing an audio output, a memory card controller 32 for controlling write/read of data to/from a detachable memory card 31, a user interface controller 34 for processing an input from a user operation input section 33 (including display mode changing switch S1), a data output section 36 for performing data input/output with respect to the external display apparatus in a wired or wireless manner, and a bus 35 for transmitting a signal among the respective sections described above.

The CPU 21 executes various kinds of arithmetic processing and control by using the main memory 22 as a work area based on a program or data stored in the program/data storage section 23, an input from the user operation input section 33 or the display mode changing switch Si, and the like.

The main memory 22 is constituted of, for example, a high-speed memory that enables read and write in a random manner, such as RAM (Random Access Memory).

The program/data storage section 23 is a read-only or read/writable nonvolatile storage apparatus, such as a ROM (Read Only Memory), a flash ROM, or a disk drive.

Specifically, the display device 26 includes a CRT (Cathode Ray Tube), an LCD (Liquid Crystal Display), a PDP (Plasma Display Panel), an OEL (Organic Electroluminescence), and the like.

The detachable memory card 31 includes a memory stick, an SD (Secure Digital) memory card, a Compact Flash (registered trademark), a Smart Media, an MMC (Multi Media Card), and the like.

Specifically, the user operation input section 33 includes a keyboard (including display mode changing switch S1), a mouse, an IR (Infrared) remote controller, a jog dial, a push button, and the like.

The network interface section 25 is, for example, an analog modem, a LAN (Local Area Network), an ISDN (Integrated Services Digital Network), an ADSL (Asymmetric Digital Subscriber Line), an FTTH (Fiber-To-The-Home), or Bluetooth.

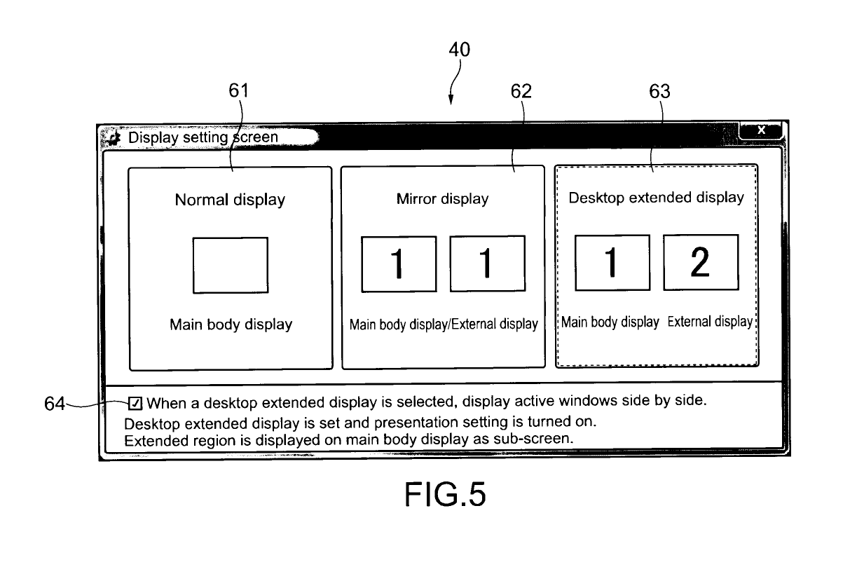

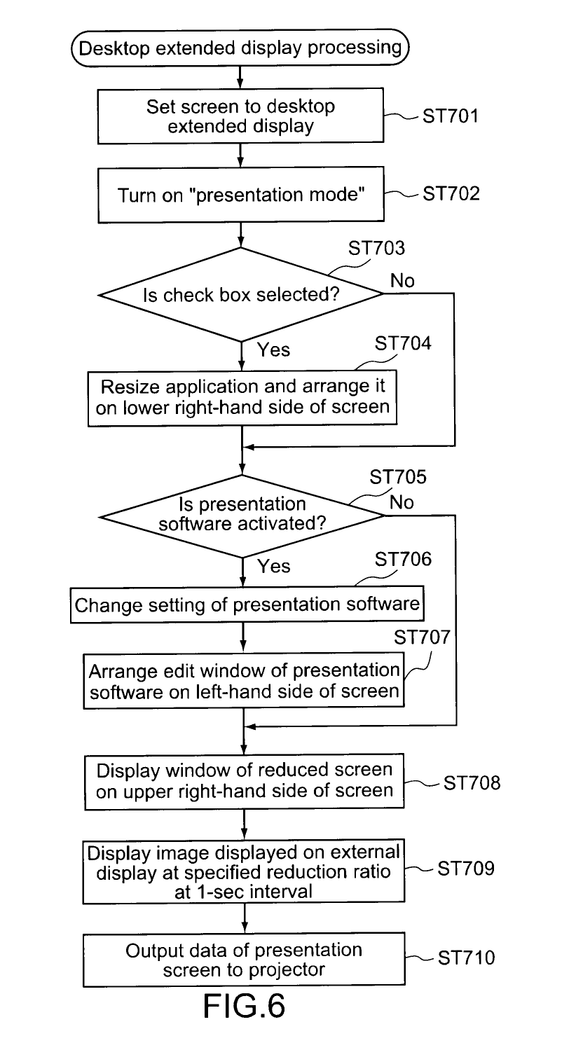

FIG. 4 is a flowchart showing an operation at a time of activation of the laptop personal computer 2. FIG. 5 is a diagram showing a display setting screen that is displayed at the time of activation of the laptop personal computer 2.

When a user presses a power switch of the laptop personal computer 2, the CPU 21 activates an OS (Operating System) and then activates utility software (ST 501) to initialize the display screen 10 of the laptop personal computer 2 (ST 502). When the display screen 10 of the laptop personal computer 2 is initialized, the CPU 21 displays on the display screen 10 a display setting screen 40 for setting a display mode (ST 503), the display setting screen 40 being shown in FIG. 5. The display mode is set through a setting by a user on the display setting screen 40. It should be noted that the display setting screen 40 is displayed on the display screen 10 not only at the time of activation but also at a time when the user presses the display mode changing switch S1. Moreover, it is also possible for the display setting screen 40 to be displayed only when the user has pressed the display mode changing switch S1 and not at the time of activation.

As shown in FIG. 5, displayed side by side on the display setting screen 40 are a normal display selecting area 61, a mirror display selecting area 62, and a desktop-extended-display-selecting area 63, with which the user can make a selection on the display screen 10. A check box 64 is displayed in a lower area of the display setting screen 40.

The normal display selecting area 61 is a button for setting a display mode to a “normal display mode”. The normal display mode is, for example, a display mode in which an image or the like can be displayed on the display screen 10 of the laptop personal computer 2 but a screen that is displayed on the display screen 10 of the laptop personal computer 2 is not displayed on the large-size screen 4.

The mirror display selecting area 62 is a button for setting a display mode to a “mirror display mode”. The mirror display mode is, for example, a display mode in which a screen displayed on the display screen 10 of the laptop personal computer 2 and a screen projected on the large-size screen 4 by the projector 3 are the same.

The desktop-extended-display-selecting area 63 is a button for setting a display mode to a “desktop extended display mode”. The desktop extended display mode is, for example, a display mode in which a screen displayed on the display screen 10 of the laptop personal computer 2 and a screen displayed on the large-size screen 4 by the projector 3 are different from each other as described below.

The check box 64 is a check box for setting (selecting), when the desktop-extended-display-selecting area 63 is selected by a user, whether to display windows of application software or the like that are active on the laptop personal computer 2 side by side on the display screen 10 or not. When the check box 64 is checked, the windows of application software or the like that are active on the display screen 10 are resized and simultaneously displayed side by side in designated areas. When the check box 64 is not checked, the windows of application software or the like that are active on the display screen 10 are not influenced at all.

When the normal display selecting area 61 is selected by a user in a state where the display setting screen 40 is displayed on the display screen 10, as shown in FIG. 4, the CPU 21 stores setting information of the display mode in the main memory 22 such that an image can be displayed only on the display device 26 (display screen 10) of the laptop personal computer 2, and sets the display mode to the normal display mode (ST 504). The CPU 21 turns off setting information of a “presentation setting (presentation mode)” (ST 505). The presentation setting is, for example, a setting for preventing automatic activation of a screen saver when the setting is an on-state, or preventing the laptop personal computer 2 from automatically entering a sleep mode during the presentation by the user. Through ST 505, the screen saver is automatically activated or the laptop personal computer 2 enters the sleep mode automatically in the normal display mode, for example.

When the mirror display selecting area 62 is selected by the user in the state where the display setting screen 40 is displayed on the display screen 10, as shown in FIG. 4, the CPU 21 stores the setting information of the display mode in the main memory 22 such that the screen displayed on the display screen 10 of the laptop personal computer 2 and the presentation screen 5 projected on the large-size screen 4 by the projector 3 are the same, and sets the display mode to the mirror display mode (ST 506). The CPU 21 turns on the setting information of the “presentation setting (presentation mode)” (ST 507). Through this setting, it is possible to prevent, for example, the automatic activation of the screen saver or the laptop personal computer 2 from automatically entering the sleep mode when the user is making a presentation. Moreover, the CPU 21 outputs to the projector 3 image information with which the projector 3 can perform display.

When the desktop-extended-display-selecting area 63 is selected by the user in the state where the display setting screen 40 is displayed on the display screen 10, the CPU 21 executes desktop extended display processing (ST 508) shown in FIG. 4.

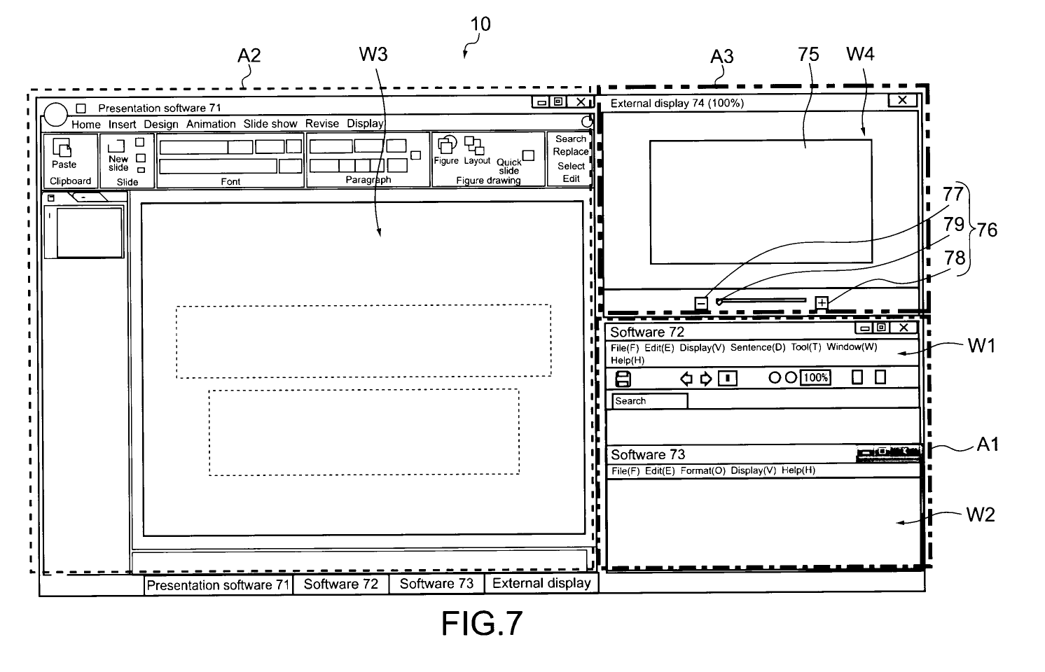

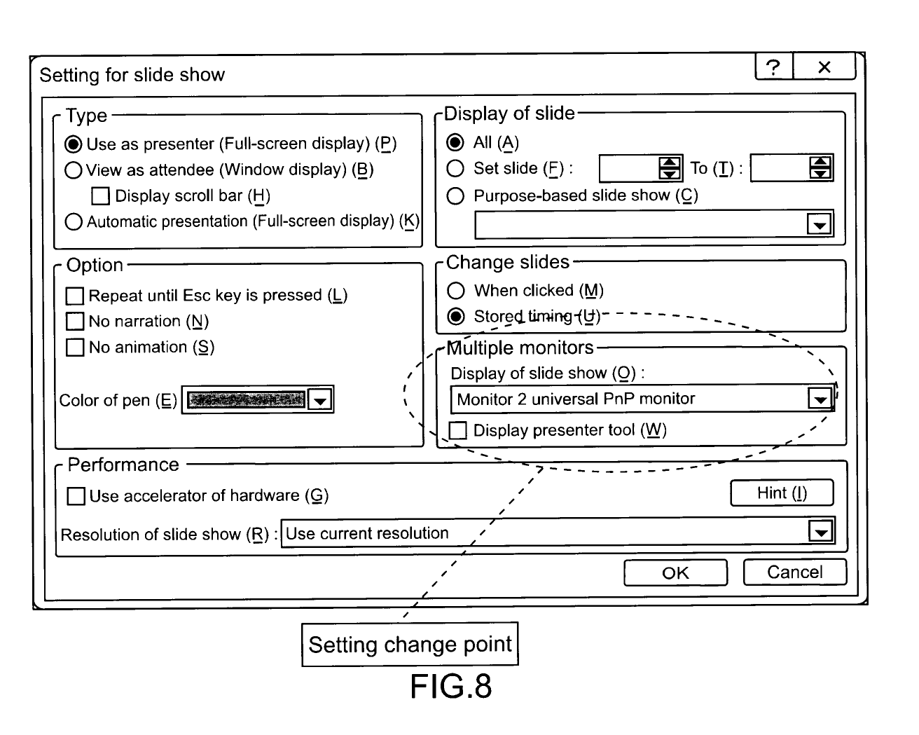

FIG. 6 is a diagram showing a flowchart of the desktop extended display processing of ST 508. FIG. 7 is a diagram showing an example of the display screen 10 of the laptop personal computer 2 in a desktop extended display mode.

It should be noted that in a description made below (FIGS. 6 and 7), a case where application software 71, 72, and 73 are active on the display screen 10 will be described.

Here, the application software 71 (hereinafter, referred to as presentation software 71) is software that is capable of supporting a presentation. In other words, the application software 71 is software that is capable of realizing an effective function in making a presentation, for example, a function of displaying a plurality of images one by one in slide at predetermined timings.

The application software 72 is software that is capable of supporting a presentation when a presentation is made using the presentation software 71. The application software 72 is, for example, character (image) input/output software.

The application software 73 is software that is incapable of supporting a presentation when a presentation is made using the presentation software 71. The application software 73 is, for example, game software irrelevant to the presentation.

As shown in FIG. 6, the CPU 21 stores setting information of the display mode in the main memory 22 such that the screen displayed on the display screen 10 of the laptop personal computer 2 and the screen projected on the large-size screen 4 by the projector 3 are different from each other, and sets the display mode to the desktop extended display mode (ST 701).

The CPU 21 turns on the setting information of the “presentation setting” as in ST 507 (ST 702). Through this setting, it is possible to, for example, prevent automatic activation of a screen saver, prevent the laptop personal computer 2 from automatically entering the sleep mode when the user is making the presentation, set a sound volume, or install a background.

The CPU 21 judges whether the check box 64 shown in FIG. 5 is checked or not (ST 703).

When the check box 64 is checked (YES in ST 703), the CPU 21 resizes windows W1 and W2 of the application software 72 and 73, respectively, as shown in FIG. 7 and displays them in an application-software-displaying area A1 of the display screen 10 (ST 704). The application-software-displaying area A1 is, for example, an area indicated by a dashed line on the lower right-hand side of the display screen 10. In this case, the CPU 21 displays, for example, the equally-contracted windows W1 and W2 of the application software 72 and 73 in the application-software-displaying area A1. It should be noted that the size of the windows W1 and W2 of the application software 72 and 73 is not particularly limited. For example, in accordance with information such as a use frequency of the application software 72 and 73 and the like, a window of application software that is frequently used may be displayed to be larger than a window of application software that is less used, in the application-software-displaying area A1.

When the CPU 21 judges in ST 703 that the check box 64 shown in FIG. 5 is not checked (NO in ST 703), the CPU 21 does not execute ST 704 and proceeds to ST 705.

The CPU 21 judges whether the presentation software 71 is being executed or not (ST 705).

When the CPU 21 judges that the presentation software 71 is being executed (YES in ST 705), the CPU 21 changes the setting information of the presentation software 71 (ST 706).

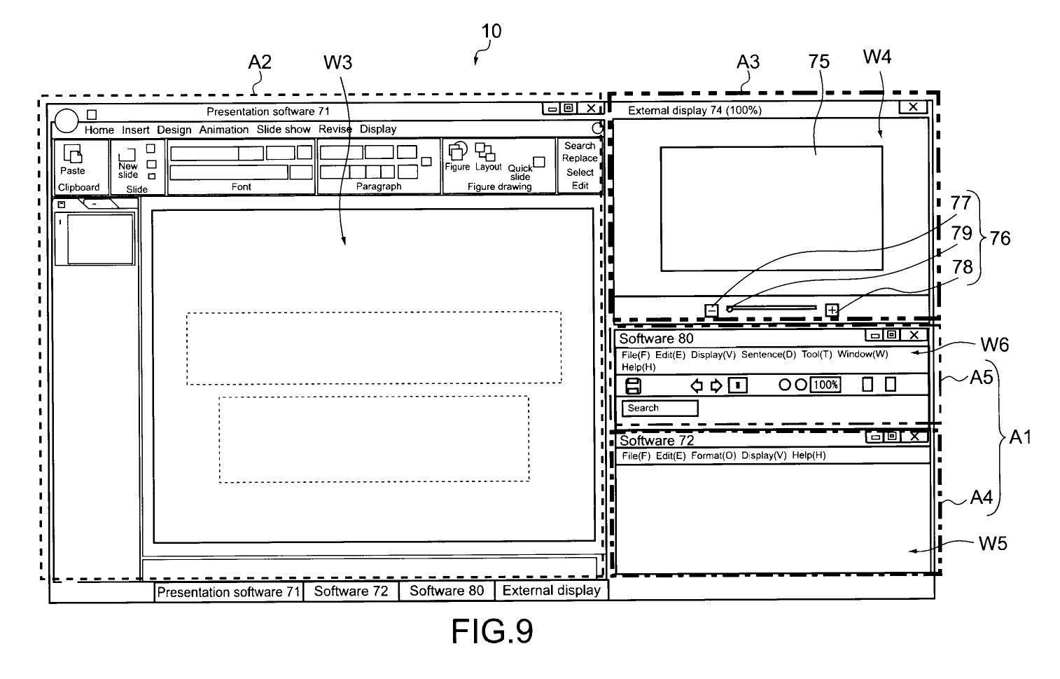

In other words, although, in the past, a setting change screen (setting screen of slide show) of the presentation software 71 shown in FIG. 8 has been displayed on the display screen 10 so that the user can set a monitor for displaying the slide show in an item “multiple monitors” shown in FIG. 8, in ST 706, the CPU 21 sets a monitor automatically.

The CPU 21 displays an edit window W3 of the presentation software 71 shown in FIG. 7 in a presentation-software-displaying area A2 of the display screen 10 (ST 707). The presentation-software-displaying area A2 is an area indicated by a dashed line in FIG. 7. In this case, the presentation-software-displaying area A2 is, for example, an area on the left-hand side of the display screen 10.

When the presentation software 71 is not being executed (NO in ST 705), the CPU 21 does not execute the processing of ST 706 and ST 707 and proceeds to ST 708.

The CPU 21 executes external-display-displaying software 74 and displays on an external-display-displaying area A3 a window W4 of a reduced screen 75 that is an image corresponding to the image information output to the projector 3 by the laptop personal computer 2 (ST 708). The reduced screen 75 is the same screen obtained by reducing the presentation screen 5 that is projected on the large-size screen 4 by the projector 3. The external-display-displaying area A3 is an area on the upper right-hand side of the display screen 10 shown in FIG. 7, for example, and is an area indicated by a chain double-dashed line. It should be noted that the processing order of ST 704, ST 707, and ST 708 may be changed without being limited thereto.

Within the window W4 of the external-display-displaying software 74, as shown in FIG. 7, an enlargement/reduction ratio setting section 76 for setting an enlargement/reduction ratio of the reduced screen 75 is displayed in a lower area of the window W4. The enlargement/reduction ratio setting section 76 includes a minus button 77, a plus button 78, and an enlargement/reduction ratio setting lever 79. The minus button 77 is a button for reducing a display magnification of the presentation screen 5 that is displayed as the reduced screen 75. The plus button 78 is a button for enlarging the display magnification of the presentation screen 5 that is displayed as the reduced screen 75. The enlargement/reduction ratio setting lever 79 can be moved from side to side between the minus button 77 and the plus button 78, for example, through a drag operation of a mouse by a user. When a position of the enlargement/reduction ratio setting lever 79 is adjusted, the display magnification of the reduced screen 75 can be enlarged or reduced.

In this case, the CPU 21 normally performs decoding processing for displaying the reduced screen 75 at predetermined time intervals while thinning out the decoding processing at a constant ratio (ST 709). In other words, the CPU 21 reduces the number of times the decoding processing is performed per predetermined unit time for displaying the reduced screen 75 so that it becomes smaller than that in a usual case. Thus, the number of times the decoding processing of the reduced screen 75 is performed per predetermined unit time is reduced, with the result that a load on the CPU 21 or the like is reduced.

Specifically, the presentation software 71 includes a function of executing processing that imparts a high load on the CPU 21, such as animation. In a case where such animation processing is displayed on both the external display such as the projector 3 and the display screen 10 of the laptop personal computer 2, an animation processing speed of the external display may be lowered depending on processing performance of the CPU 21. In this regard, the decoding processing of the reduced screen 75 is thinned out at predetermined time intervals so that the load on the CPU 21 can be reduced and the reduced screen 75 at hand of the user can be displayed without affecting proper progress processing of the presentation. It should be noted that the intervals at which the processing is thinned out are not constant, and may be changed in accordance with the load on the CPU 21.

Furthermore, the data output section 36 outputs the screen information of the presentation software 71 to the projector 3 (ST 710).

A size of the presentation-software-displaying area A2 is equal to or larger than half the size of the display screen 10, for example. The application-software-displaying area A1 has a size substantially the same as a size of the external-display-displaying area A3, for example.

As described above, according to this embodiment, the laptop personal computer 2 includes the display mode changing switch S1 for changing display modes and can display the display setting screen 40 on the display screen 10 in response to an operation signal input when the display mode changing switch S1 is pressed. In accordance with the setting made by the user on the display setting screen 40, the laptop personal computer 2 can turn on the presentation setting for preventing automatic activation of a screen saver (ST 702). Moreover, as shown in FIG. 7, the edit window W3 of the presentation software 71, the window W4 of the reduced screen 75, and the windows W1 and W2 of the application software 72 and 73 can be displayed on the display screen 10 (ST 704, ST 707, and ST 708). Specifically, by the user merely pressing the display mode changing switch S1 and making settings on the display setting screen 40, the setting for supporting a presentation and display of the respective screens can be made with ease. As a result, the user can edit data in the edit window W3 and take notes in the window W1 while viewing the reduced screen 75 or materials, whereby the presentation can be made more easily.

More specifically, even when the large-size screen 4 of the projector 3 cannot be directly viewed, the user can make the presentation easily while viewing the display screen 10 that is the same screen as the presentation screen 5 that the audiences are viewing on the large-size screen 4. Moreover, it is possible to display on the application-software-displaying area A1, aside from information displayed in the edit window W3 of the application software 71 or on the reduced screen 75, information of hand-written notes of questions and answers or information of materials on hand that has been prepared in advance so that the presentation can be made while viewing or taking notes and also referring to the materials.

In the past, in order that the user might make the presentation setting, it has been necessary for the user to sequentially select, for example, a control panel, a mobile computer, and a Windows (registered trademark) Mobility Center in a welcome screen of a laptop personal computer, for example, and turn on the presentation setting. In other words, complicated settings have been required each time so as to make the presentation easier. In this embodiment, the CPU 21 makes the presentation settings automatically in ST 702, which is more user-friendly.

The laptop personal computer 2 can display the check box 64 within the display setting screen 40. Through the easy operation of checking the check box 64, it is possible to resize automatically the windows W1 and W2 of the application software 72 and 73 in the desktop extended display mode and arrange the windows W1 and W2 side by side in the application-software-displaying area A1. Moreover, display/nondisplay of the windows W1 and W2 of the application software 72 and 73 may be switched therebetween using the check box 64, in addition to the automatic arrangement of the windows. It is also possible that, for example, by removing the check of the check box 64 to set it off, the windows of the application software 72 and 73 become hidden and the window W4 of the external-display-displaying software 74 is displayed manually or automatically in an area larger than the external-display-displaying area A3. Accordingly, the presentation screen 5 that is displayed on the large-size screen 4 can be displayed more largely, contents of the presentation screen 5 can be grasped more correctly, and a presentation can be made more smoothly.

When the mirror display selecting area 62 or the desktop-extended-display-selecting area 63 is selected by the user on the display setting screen 40 shown in FIG. 5, it is desirable for the laptop personal computer 2 to automatically store luminance setting information for setting luminance that is smaller than luminance of the large-size screen 4 in a normal operation mode in the main memory 22. Thus, the projector 3 can set luminance of the presentation screen 5 on the large-size screen 4 to be smaller than that at the normal operation mode based on the luminance setting information, and can thus prevent the presentation screen 5 from becoming excessively bright during the presentation.

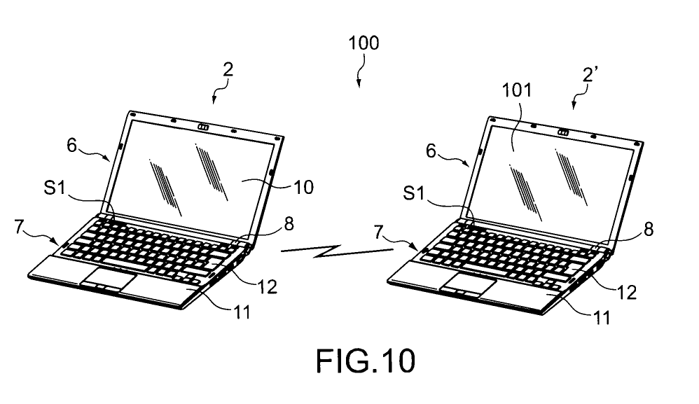

FIG. 9 is a diagram showing a display screen 10 of a desktop extended display of a first modified example.

This modified example is different from the embodiment described above in that the CPU 21 controls each size of windows of application software that are displayed in the application-software-displaying area A1, in accordance with whether the plurality of application software 72 and the like that are being executed can support a presentation or not.

For example, it is desirable for the user to register in advance application software that can support a presentation. For example, if a registration program for this registration is installed in advance in the laptop personal computer 2, such control is made possible.

For example, a case where the display mode changing switch S1 is pressed by the user when the presentation software 71, the application software 72 that can support a presentation, and application software 80 that cannot support a presentation are executed will be discussed. In this case, the CPU 21 resizes a window W5 of the application software 72 that can support a presentation to be larger than a window W6 of the application software 80 and displays the windows in the application-software-displaying area A1. For example, an application-software-displaying area A4 indicated by a dashed line in FIG. 9 is an area in which the window W5 of the application software 72 is displayed. For example, an application-software-displaying area A5 indicated by a chain double-dashed line in FIG. 9 is an area in which the window W6 of the application software 80 is displayed. The application-software-displaying area A4 (window W5) is displayed larger than the application-software-displaying area A5 (window W6).

Thus, the window W5 of the application software 72 (such as character (image) input/output software) that supports a presentation during the presentation is displayed larger than the window W6 for game software and the like, and the limited display screen 10 is utilized effectively in order to take notes or the like, whereby the presentation can be made more easily.

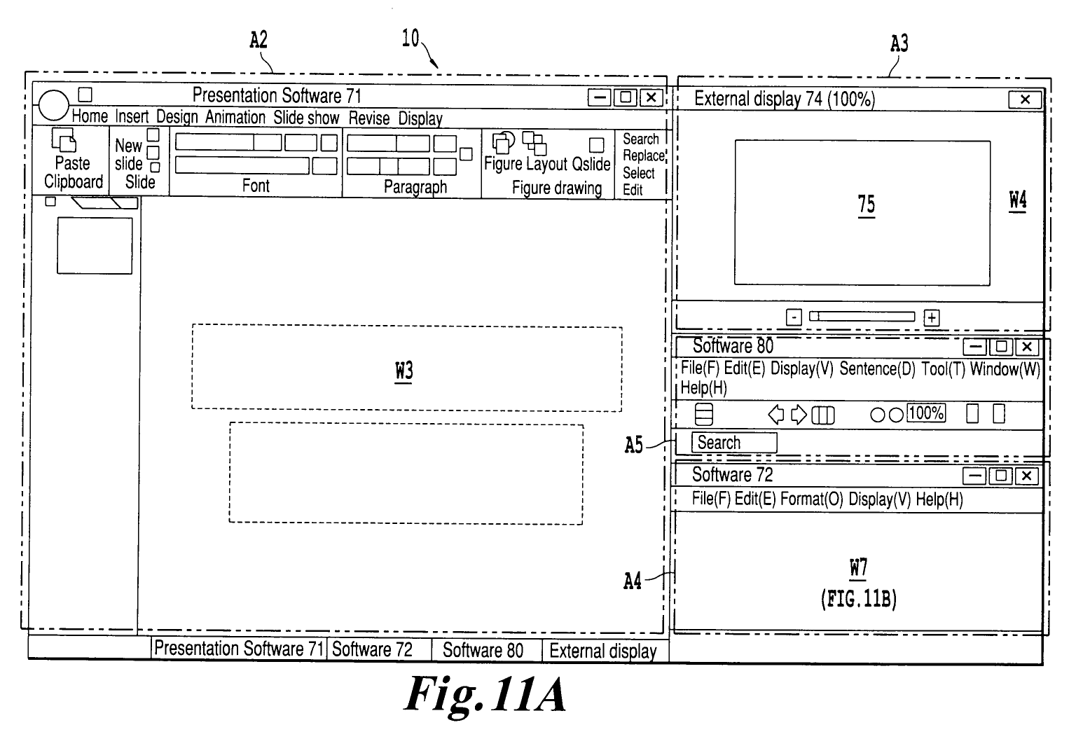

FIG. 10 is a diagram showing an information processing system of a second modified example.

As shown in FIG. 10, an information processing system 100 of this modified example is different from the information processing system 1 of the embodiment described above in that a laptop personal computer 2′ is used as the external display apparatus (external display) instead of the projector 3. The laptop personal computer 2 and the laptop personal computer 2′ are structured so as to enable wireless or wired communication as described above.

With such a structure, similarly to the embodiment described above, the edit window W3 of the presentation software 71, the window W4 of the reduced screen 75, and the windows W1 and W2 of the application software 72 and 73 that are shown in FIG. 7 can be displayed on the display screen 10 of the laptop personal computer 2 while displaying the presentation screen on a display screen 101 of the laptop personal computer 2′. As a result, also when the presentation is made using the laptop personal computers 2 and 2′, the setting of the presentation can be made easily and accordingly the presentation can be made more easily.

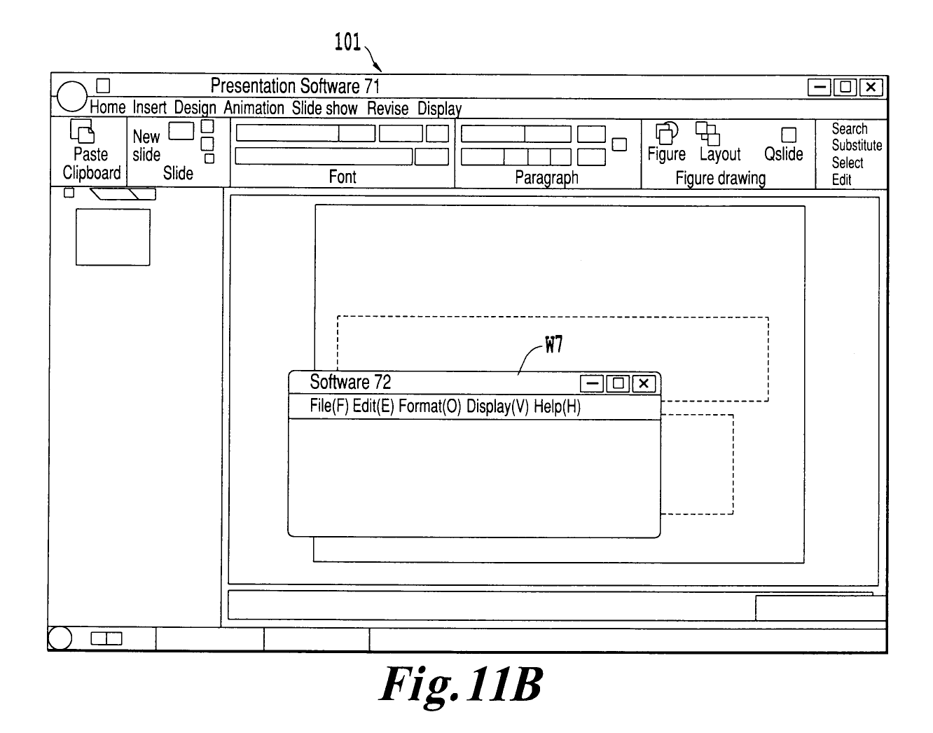

FIG. 11 is a diagram showing an example of an operation using the laptop personal computers 2 and 2′.

As shown in FIG. 11, when the display mode is the desktop extended display mode, for example, the user can cancel the desktop extended display mode by pressing an escape button (Esc) of the laptop personal computer 2. After that, for example, by dragging a window W7 of the application software 72 and dropping the window W7 on, for example, the display screen 101, the user can display the window W7 on the display screen 101. With such a structure, the user can show the notes that have been taken using the application software 72 instantly to the audiences viewing the display screen 101 during his/her presentation.

In the embodiment described above and the like, the example in which, when the desktop extended display mode is set, the edit window W3 of the presentation software 71 is displayed on the left-hand side of the display screen 10, the window W4 of the external-display-displaying software 74 is displayed on the upper right-hand side of the display screen 10, and the windows W1 and W2 of the application software 72 and 73 are displayed on the lower right-hand side of the display screen 10 has been described. However, an area in which each of the windows W1 to W4 is displayed and sizes of the windows W1 to W4 are not particularly limited, and can be changed variously in accordance with usability for users.

In the embodiment and modified examples described above, the example in which the laptop personal computer 2 is used as the information processing apparatus and the projector 3 or the laptop personal computer 2′ is used as the external display apparatus has been described. However, the information processing apparatus and the external display apparatus are not limited thereto. For example, a desktop personal computer may be used as the information processing apparatus, and various types of electronic apparatuses such as a desktop personal computer and a television may be used as the external display apparatus. With such a structure as well, the presentation can similarly be made more easily.

In the embodiment and modified examples described above, the example in which the display mode changing switch S1 is provided in the vicinity of the hinge portion 8 of the main body portion 7 of the laptop personal computer 2 has been described, for example. However, the position at which the display mode changing switch S1 is provided is not limited thereto. The display mode changing switch S1 may be provided to the hinge portion 8 or on a side surface of the main body portion 7. With such a structure as well, a display mode changing setting can be started with ease through a one-touch operation by the user.

In the embodiment and modified examples described above, the example in which the normal display selecting area 61, the mirror display selecting area 62, and the desktop-extended-display-selecting area 63 are displayed side by side on the display setting screen 40 has been described. However, the present invention is not limited thereto. For example, a check box or a radio button may be displayed within the display setting screen so that the user can select the display modes. With such a structure, the user can select and set the display mode with ease as in the embodiment above and the like.

In the embodiment and modified examples described above, the example in which the check box 64 on the display setting screen 40 is used to set (select) whether to display windows of other application software that are different from the presentation software 71 side by side on the display screen 10 has been described. However, various selection buttons such as a radio button may be used without being limited to the check box 64.

In the embodiment and modified examples described above, the example in which the enlargement/reduction ratio setting section 76 (minus button 77, plus button 78, and enlargement/reduction ratio setting lever 79) is provided in order to change the enlargement/reduction ratio of the reduced screen 75 has been described. However, the enlargement/reduction ratio setting section is not limited thereto, and may receive directly an input of a numerical value of an enlargement/reduction ratio with respect to the size of a normal screen. With such a structure as well, similarly to the embodiment above and the like, the presentation can be made more easily by enlarging or reducing the reduced screen 75.

The present invention is not limited to the embodiment and modified examples described above, and as a matter of cause, various updates may be added thereto without departing from the gist of the present invention.

The present application contains subject matter related to that disclosed in Japanese Priority Patent Application JP 2008-181870 filed in the Japan Patent Office on Jul. 11, 2008, and Japanese Priority Patent Application JP 2008-203394 filed in the Japan Patent Office on Aug. 6, 2008, the entire content of which is hereby incorporated by reference.

What is claimed is:

1. An information processing apparatus, comprising:
an output means for outputting image information for a presentation to an external display apparatus;
a display screen that is capable of displaying information; and
a screen arrangement means for arranging a first area and a second area on the display screen with a positional relationship preset for the display screen, the first area displaying an image corresponding to the image information that has been output to the external display apparatus, the second area being an area in which the image information can be edited.

2. The information processing apparatus according to claim 1, further comprising
a setting means for receiving a setting of on/off of the screen arrangement means which is made by a user.

3. The information processing apparatus according to claim 2,
wherein the screen arrangement means arranges a screen of an application other than the presentation as a third area on the display screen in addition to the first area and the second area.

4. The information processing apparatus according to claim 3, further comprising:
an input means for receiving an input of an operation signal from a user; and
means for causing the setting means to display a setting screen for receiving the setting of on/off of the screen arrangement means which is made by a user on the display screen in accordance with the operation signal.

5. The information processing apparatus according to claim 4, further comprising
means for setting whether to display the third area on the display screen or not.

6. The information processing apparatus according to claim 5,
wherein the third area includes
a fourth area that is a screen of a first application that supports a presentation, and
a fifth area that is a screen of a second application that does not support the presentation, and
wherein the screen arrangement means arranges the fourth area to be larger than the fifth area.

7. The information processing apparatus according to claim 6, further comprising
a display control means for controlling the number of times processing for displaying the image in the first area is performed per unit time.

8. The information processing apparatus according to claim 7, further comprising
an illumination control means for controlling illumination of a screen of the external display apparatus.

9. The information processing apparatus according to claim 8, further comprising
an enlargement/reduction ratio control means for controlling an enlargement/reduction ratio of the image displayed in the first area.

10. An information processing apparatus, comprising:
an output means for outputting first information to a first display apparatus; and
a second output means for outputting a first area and a second area to a second display apparatus in accordance with positions preset for the second display apparatus, the first area displaying information corresponding to the first information that has been output to the first display apparatus, the second area being an area for editing the first information that has been output to the first display apparatus.

11. An information processing method, comprising:
outputting, by an information processing apparatus, image information for a presentation to an external display apparatus; and
arranging, with a positional relationship preset for a display screen of the information processing apparatus, a first area and a second area on the display screen, the first area displaying an image corresponding to the image information, the second area being an area in which the image information can be edited.

12. The information processing method according to claim 11, further comprising
prompting a user to set on/off of the arrangement of the first area and the second area on the display screen.

13. An information processing system, comprising:
an external display apparatus input with image information for a presentation; and
an information processing apparatus including
an output means for outputting the image information to the external display apparatus,
a display screen that is capable of displaying information, and
a screen arrangement means for arranging a first area and a second area on the display screen with a positional relationship preset for the display screen, the first area displaying an image corresponding to the image information that has been output to the external display apparatus, the second area being an area in which the image information can be edited.

14. A program causing a computer to function as an information processing apparatus, the program causing the computer to execute:
outputting image information for a presentation to an external display apparatus; and
arranging, with a positional relationship preset for a display screen of the information processing apparatus, a first area and a second area on the display screen, the first area displaying an image corresponding to the image information, the second area being an area in which the image information can be edited.

15. An information processing method, comprising:
outputting, by an information processing apparatus, first information to a first display apparatus; and
outputting a first area and a second area to a second display apparatus in accordance with positions preset for the second display apparatus, the first area displaying information corresponding to the first information that has been output to the first display apparatus, the second area being an area for editing the first information that has been output to the first display apparatus.

16. An information processing apparatus, comprising:
an output section to output first information to a first display apparatus; and
a second output section to output a first area and a second area to a second display apparatus in accordance with positions preset for the second display apparatus, the first area displaying information corresponding to the first information that has been output to the first display apparatus, the second area being an area for editing the first information that has been output to the first display apparatus.
